(19) United States
(12) Patent Application Publication
(10) Pub. No.: US 2007/0058614 A1
(43) Pub. Date: Mar. 15, 2007

(54) BANDWIDTH UTILIZATION FOR VIDEO MAIL

(76) Inventors: Jon S. Plotky, Lawrenceville, GA (US); James H. Spencer, Tucker, GA (US)

Correspondence Address: SMITH FROHWEIN TEMPEL GREENLEE BLAHA, LLC, P.O. BOX 88148, ATLANTA, GA, 30356, US

(21) Appl. No.: 11/307,593

(22) Filed: Feb. 14, 2006

Related U.S. Application Data
(63) Continuation-in-part of application No. 11/170,530, filed on Jun. 29, 2005.
(60) Provisional application No. 60/584,117, filed on Jun. 30, 2004.

(51) Int. Cl. H04L 12/66; H04L 12/56

(52) U.S. Cl. 370/352; 370/401

(57) ABSTRACT

Video content is delivered in a bandwidth efficient manner to a destination device. The video content is analyzed and a compression operation is performed on the video content prior to delivery to the destination device. Any audio associated with the video content is maintained in synchronization with the video content. The compression of the video can be performed in a variety of manners including single transmission of static frames, combining substantially similar frames so that only a single frame representing the combination is transmitted, and only transmitting dynamically changing or active portions of the video content.

### CROSS-REFERENCE TO RELATED APPLICATIONS

This application is a continuation-in-part of United States patent application filed on Mar. 15, 2005 and assigned Ser. No. 11/080,744, United States patent application filed on Jun. 29, 2005 and assigned Ser. No. 11/170,459, and United States patent application filed on Jun. 29, 2005 and assigned Ser. No. 11/170,530, each of which claim the benefit of the filing date of United States Provisional Application for Patent entitled DISTRIBUTED IP ARCHITECTURE FOR TELECOMMUNICATIONS SYSTEM, filed on Jun. 30, 2004 and assigned Ser. No. 60/584,117.

This application is related to a U.S. patent application that has a title of DISTRIBUTED IP ARCHITECTURE FOR TELECOMMUNICATIONS SYSTEM WITH VIDEO MAIL, was filed concurrently with this application and is hereby incorporated by reference in its entirety.

### BACKGROUND OF THE INVENTION

The present invention relates to the provision of video mail in a telecommunications system and, more particular to the bandwidth utilization and the user interface associated with receiving video mail, messages and other related video material.

If you head out anywhere in public today, you are certain to see someone hunched over a BLACKBERRY device, feverishly typing away on a miniature key board with their thumbs. What are they doing? They are one of the many people that are consumed in the email-age of our planet. And if you don't see such a sight, you are certain to see a handful of people busily chatting away on their cellular telephones, leaving messages are retrieving their voice mail. The evidence is certainly in—we live in a connected world.

What's next? Cellular technology is continually under construction. In the early 1980's, cellular technology was based on analog technology and was referred to as the analog mobile phone system (AMPS). As technology developed, digital systems were introduced including TMDA, CDMA and GSM system. The migration to digital technology opened up the cellular infrastructure to a wide range of additional features including email deliver, short messaging and the like. Advancements in technology have built on the digital cellular technology, thereby improving the bandwidth capacity and functionality of the cellular infrastructure. Today, the cellular infrastructure is rapidly migrating to the third generation wireless technology, otherwise termed as 3G, while others are already at work defining the fourth generation cellular technology. 3G technology takes another step in our electronic connectedness by increasing the bandwidth available, and thereby enabling the delivery of video information over the cellular network in a manner that somewhat user enjoyable. However, many complexities are present in actually developing and deploying user friendly, bandwidth efficient, reliable and user desired video based services over the wireless network. Even though bandwidth capacities are greatly increased, the transmission of video information can still be cumbersome.

In providing video messaging solutions over a 3G wireless network, an important issue is the provision of a useful, effective and bandwidth efficient user interface. Thus, there is a need in the art for a solution to provide state-of-the art user interfaces and video functionality that efficiently utilizes the bandwidth available in the cellular infrastructure. Such a solution should not only benefit the current cellular technology, but also be applicable for the efficient use of bandwidth in future migrations of cellular technology.

### BRIEF SUMMARY OF THE INVENTION

The present invention provides a solution to the afore-mentioned needs in the art by providing bandwidth efficient delivery of video information to end user devices in a digital cellular network. Advantageously, aspects of the present invention provide a useful, effective and bandwidth efficient user interface over a cellular system and/or network that supports video messaging or content. More specifically, one embodiment of the present invention operates to separate the video experience from the audio experience in a video messaging user interface. In such an embodiment, a static or still image, such as a menu item, is rendered on a receiving device for display but the audio associated with the video image is provided in an independent manner. Thus, a user interface that includes a static display, such as a menu with various options, along with audio content associated with the menu, can be rendered by providing the video content once, and then independently repeating or cycling through the audio content that recites the options/instructions/prompts available for selection. Advantageously, decoupling the audio and video in such a manner greatly decreases the bandwidth required to continuously send the video content along with the repeating audio. In such an embodiment, synchronization of the audio and video is provided within a menu structure, but only on a menu page basis.

In another embodiment of the present invention, active video content is provided over the digital cellular infrastructure in a bandwidth efficient manner by compressing non-active video segments. More specifically, the video information can be processed on a frame by frame basis and filtering frames that do not significantly alter the video content. Thus, for relatively still images, significant bandwidth reduction can be attained. Alternatively, the video content can be analyzed on a content basis to isolate substantially similar video or static video from dynamic video and only transmitting enough information to accommodate the dynamically changing video. Again, this aspect of the present invention can greatly reduce the bandwidth required for transmitting the video content.

These and other aspects of the present invention will be more appreciated by reading the detailed description and the figures, along with the claims.

### BRIEF DESCRIPTION OF THE SEVERAL VIEWS OF THE DRAWING

Various aspects, features and advantages of the present invention will become fully appreciated as the same becomes better understood when considered in conjunction with the accompanying drawings, in which like reference characters designate the same or similar parts throughout the several views, and wherein:

FIG. 1 is a block diagram illustrating a distributed telecommunications platform that incorporates elements to provide video mail capabilities.

FIG. 2 is a flow diagram of an aspect of the present invention in providing bandwidth efficient delivery of still video content, such as menu screens.

FIGS. 3A and 3B are flow diagrams embodiments of the present invention operating to provide bandwidth efficient delivery of active video content.

FIG. 3C is a flow diagram illustrating an embodiment of the invention in which compress is performed on a frame-by-frame basis.

### DETAILED DESCRIPTION OF THE INVENTION

The present invention is directed towards the provision of video content over a digital wireless network, and more particularly, to the efficient utilization of bandwidth in the delivery of such video content. In general, the invention involves a technique for compressing or limiting the amount of video information that must be transmitted, while maintaining synchronization of the video with any associated audio content. Now turning to the drawings, in which like labels refer to like elements throughout the several views, various aspects and features of the present invention are described.

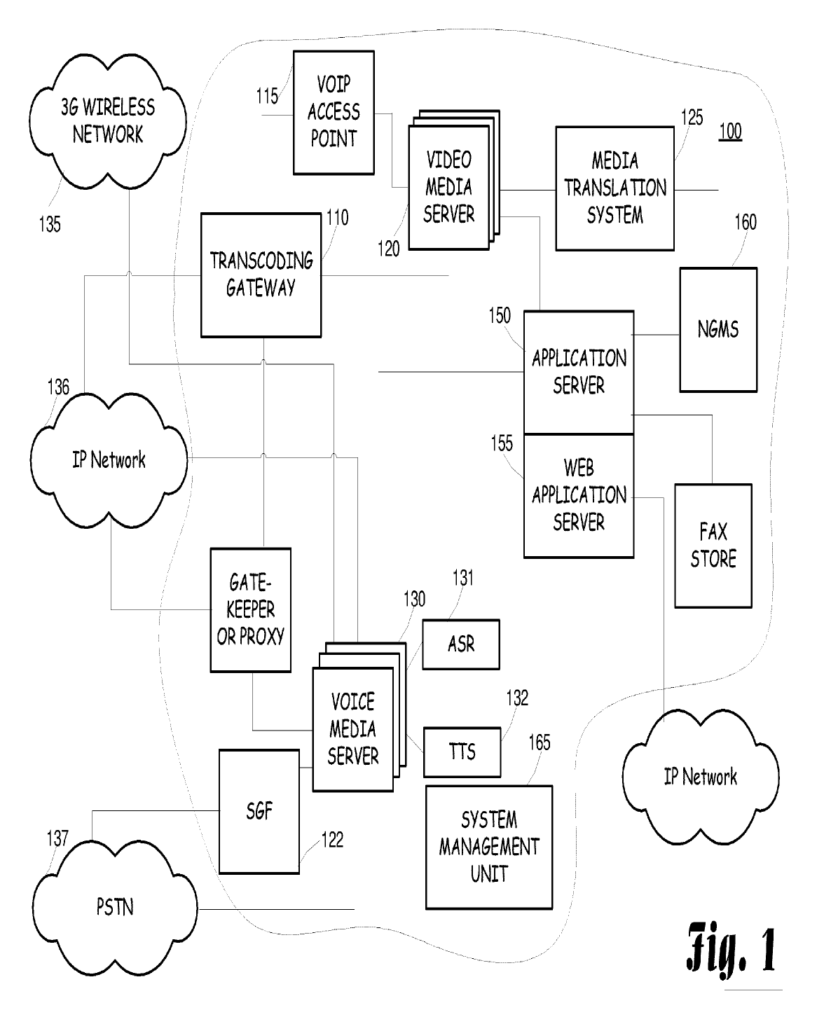

FIG. 1 is a block diagram illustrating a distributed telecommunications platform that provides video mail capabilities over a digital wireless network, as well as other telecommunication capabilities over the wireless and wired telecommunications system. It should be appreciated the overall architecture of this system is the subject of a separate application for patent and is provided in this description only for illustrative purposes. As such, the illustrated system simply provides on possible platform for implementing various embodiments of the present invention and is not provided as a limiting example.

The illustrated next-generation communications platform 100 employs a distributed IP architecture and is connected to the Public Switched Telephone Network (PSTN) 137 and a third generation wireless network 135. The communications platform 100 is illustrated as including a signaling gateway function (SGF) 122, one or more voice media servers 130, one or more system management units (SMU) 165, one or more application servers (AS) 150, one or more next generation message stores (NGMS) 160, a transcoding gateway 110 and one or more video media servers 120.

In general, the SGF 122 serves as the Signaling System 7 (SS7) interface to the PSTN 137 and allows one or more components or sub-systems to share the same point code (thereby reducing the need for destination point codes (DPC) and signaling links for call-control. This makes the telephonic system appear as single trunk group in the network, although sharing the same point code does not necessarily mean all the trunks are in a single trunk group. The voice media server 130 terminates IP and/or circuit switched traffic from the PSTN via a multi-interface design and is responsible for trunking and call control. The application server module 150 generates dynamic VoiceXML pages for various applications and renders the pages through the voice media server 130 and provides an external interface via a web application server configuration. The SMU 165 is a management portal that enables service providers to provision and maintain subscriber accounts and manage network elements from a centralized web interface. The NGMS 160 stores voice messages, subscriber records, and manages specific application functions including notification.

In general, video mail is implemented in the telecommunications platform 100 by including a transcoding gateway 110, a voice over IP access point (VOIP access point or VAP) 115, one or more video mail servers 120, and a media translation engine 125. The transcoding gateway 110 interfaces to a third generation wireless network (3G wireless network or other digital wireless network) 135 over an E1 interfaces that supports the H.324M and 3G-324M protocols or other similarly capable protocols that are in existence or are developed in the future. In addition, the transcoding gateway 110 interfaces to an IP network 136 over an H.323 interface and to the video media server 120 over another H.323 interface.

The transcoding gateway 110 is used to process incoming video messaging traffic and it physically resides between the networks (3G, IP, PSTN) and the video media server 120. The transcoding gateway 110 utilizes both E1 and IP interfaces to the networks and in an exemplary embodiment, interfaces to the video server 120 over an IP interface. In an embodiment of the present invention, the transcoding gateway 110, operates to provide transcoding and proxy functions for call signaling, call setup, command, control and indication between various multimedia systems standards including H.324M/3G-324M, H.323 and SIP. The transcoding gateway 110 preferably supports multiple voice and video codecs. The transcoding gateway 110 is operable to automatically handle clients by: detecting capabilities of client and matching and converting command and control media session announcements. In addition, the transcoding gateway 110 enables universal media experience by including capabilities exchange and mode selection to support a wide variety of devices, handsets and suppliers without the need for customization of the network.

One advantage of using a transcoding gateway 110 is that the video telephony calls can be presented to the video media server 120 in a single audio/video format. Thus, the video media server 120 may not need to provide any transcoding capabilities. Another advantage is that the transcoding gateway 110 can perform all the error handling on the interfaces to the network. Thus, the video media server 120 is not necessarily required to recreate full video frames from the video data stream. These two advantages allow the interface of video media server 120 to be simpler and thus, the video media server 120 will be less expensive yet able to handle more simultaneous calls. The transcoding gateway 110 can be proprietary or one of the commercially available products, such as the one available from Dilithium Networks (the DTG 2000), which provides up to eight E1 interfaces, as well as IP network interfaces.

Another potential advantage to using a transcoding gateway 110 is that some network operators already have them deployed in their networks to provide calling capabilities between the 3G and IP networks. Thus, in deploying embodiments of the present invention, the systems could exploit the existing transcoding gateways.

The VOIP access point 115 operates to balance traffic across the video mail servers 120. More specifically, the VOIP access point 115 distributes calls received at the transcoding gateway 110 to one of the video media servers 120 in such a manner to balance the load between the available video media servers 120.

The video media server 120 operates to terminate IP video traffic and is responsible for call set up and control of video telephony or otherwise provide the management of any video messages within the system. The voice media server 120 can process input from a user in DTMF format (much like a web client gathers keyboard and mouse click input from a user) but can also employ other techniques for information input, such as voice recognition. It then presents content to the user in video and voice form (similar in principle to graphic and text display back to the user on a PC client). This client server methodology enables rapid creation of new applications and quick utilization of content available on the World Wide Web. In an exemplary embodiment, each voice media server 120 includes a client interface for callers and supports voiceXML and Java Script. The application environment for the video mail servers 120 is similar to that as described for the voice media servers 130 below. Each video media server 120 can support approximately between 30-60 simultaneous video calls. Further features of an exemplary video media server 120 include providing call data records, logging and alarm management, telephony management functions, and host media processing.

When a video call is received by the system, the video media server 120 answers the call just as if it were a video-capable terminal. No special client is required on the caller's videophone. The video media server 120 prompts the caller with both voice prompts and video displays. When recording a message, the video media server 120 captures both the video and audio data, keeping the data synchronized for playback.

The video media server 120 processes incoming calls via requests to the applications server 150 using HTTP. A load balancer directs traffic arriving at the video media server 120 to one of a plurality of applications servers 150. This functionality ensures that traffic is allocated evenly between servers and to active servers only. The video media server 120 works as the VoiceXML client on behalf of the end user in much the same manner as a client like Netscape works on behalf of an HTML user on a PC. A VoiceXML browser residing on a video media server 120 interprets the VoiceXML documents for presentation to users.

The video media server 120 interfaces with transcoding gateway 110 using H.323. The transcoding gateway 110 translates the various audio and video codecs used in 3G-324M and H.323 to G.711 audio and H.263 video for the video media server 120. The VoIP Access Point (VAP) acts as a load balancer to direct incoming calls among the available voice media servers 120. Each video media server 120 constantly communicates its status to the VAP. The VAP routes calls only to video media servers 120 that are running and ready for traffic. Call Detail Records (CDRs) are provided, as well as SNMP alarming, logging, and transaction detail records.

The application server 150 operates to generate dynamic voice XML (VXML) pages or information, manages application processing of any video content and includes an external interface through the web application server 155. The application server 150 interfaces to both the video media servers 120 and the voice media servers 130 and, in response to various requests received from the video media servers 120 and the voice media servers 130, generates appropriate VXML pages or data. Utilizing a web application infrastructure, the application server 150 interfaces with backend data stores (such as the NGMS 160 or user profile databases, content servers or the like). The utilization of the web application infrastructure allows for separation of the core service logic (i.e., providing the business logic) from the presentation details (VXML, CCXML, SALT, XHTML, WML) to provide a more extensible application architecture.

In an exemplary embodiment, the applications server 150 utilizes Java 2 Enterprise Edition (J2EE) environment and Java Server Pages (JSP) to create the dynamic VoiceXML pages for the media servers. To create an environment for easy application development, the applications server 150 supports Template+JSPs. Applications are implemented in JSPs using a proprietary API. These JSPs are readily modifiable making changes in application behavior and creation of new applications very easy.

The voice media server 130 terminates IP and circuit-switched voice traffic and is responsible for call set up and control within the system. The voice media server 130 processes input from the user in either voice or DTMF format (much like a web client gathers keyboard and mouse click input from a user). It then presents the content back to the user in voice form (similar in principle to graphic and text display back to the user on a PC client). This client server methodology enables rapid creation of new applications and quick utilization of content available on the World Wide Web.

The voice media server 130 processes incoming calls via requests to the application server 150 using HTTP. A load balancer directs traffic arriving at the voice media server 130 to one of a plurality of applications servers 150. This functionality ensures that traffic is allocated evenly between servers, and to active servers only. The voice media server 130 works as the VoiceXML client on behalf of the end user in much the same manner as a client like Netscape works on behalf of an HTML user on a PC. A VoiceXML browser residing on the voice media server 130 interprets the VoiceXML documents for presentation to users.

The voice media server 130 interfaces with the PSTN, automatic speech recognition server (ASR) 131 and text-to-speech server 132 (TTS) and provides VoIP (SIP, H.323) support. Incoming circuit switched voice data in 64-kilobit micro-law or A-law pulse code modulation (PCM) format is compressed using G.726 for voice storage in the NGMS 160. VoIP is supported through G.711 and G.723 voice encoding. The voice media server 130 contains a built-in abstraction layer for interface with multiple speech vendors—eliminating dependency on a single ASR 131 or TTS 132 vendor.

The voice media server 130 can include built in codecs and echo cancellation. Call detail records (CDRs), used by service providers for billing purposes, are provided as well as SNMP alarming, logging, and transaction detail records.

Each of these sub-systems are described in more detail in the U.S. patent application Ser. No. 11/080,744 which was filed on Mar. 15, 2005 and to which this present application is a continuation-in-part and thus, is incorporated herein by reference.

The NGMS 160 is utilized to store voice and video messages, subscriber records, and to manage certain application functions such as notification schedules. The NGMS 160 is preferrably designed with fully redundant components and utilizes reflective memory and Redundant Array of Independent Disks (RAID) technology for fault tolerance, immediate fail over and recovery.

The NGMS 160 has notification interfaces to SMPP for SMS, SMTP for email, and SMS Alert enabling SMS direct to the handset over SS7.

The media translation engine 125 operates to translate message data between different types of encoding. For instance, the media translation engine 125 can operate to convert message data between voice and data formats and encodings. One aspect of the media translation engine 125 is that it enables the playback of video messages on a device or telephone that does not support video, as well as the playback of voice only messages on video based calls. The media translation engine 125 also provides conversion for web message access and email message delivery. Preferably, the media translation engine 125 includes a dedicated digital signal process for high throughput.

The system management unit (SMU) 165 communicates with each of the other elements and/or components in the system to provide provisioning services, alarm management and collection of customer data records (CDR). The SMU provides a centralized point for service providers to manage all network elements, providing remote access, maintenance, and backup functionality. As such, the system management unit 165 provides system configuration and setup, network management and system monitoring, statistics and reporting, fault management and alarms, subscriber and mailbox administration, computer interface for centralized provisioning, CDR capture for billing, as well as other services.

The SMU 165 provides a single interface for provisioning, alarming, reports, and subscriber migration. The SMU 165 integrates and customizes systems with new elements and applications, and provides operational support and network management functions for carriers experiencing swiftly growing networks and exploding traffic volumes. Core features of the element management component include:

Element Auto-Discovery—when service providers add new network elements, the SMU 265 automatically recognizes them and includes the new elements in the graphical network map.

Graphical Network Map—a network/cluster map and map editor provides a snapshot of the entire network or cluster and facilitates quick problem identification and resolution.

Time Synchronization—a central time source ensures all network components maintain a uniform time reference across the entire messaging network—important for any distributed architecture.

Centralized network logging—logging for the entire messaging network is centralized on the SMU 165.

For system configuration and setup, the SMU 165 supports the functions of Class of Service (COS), software configuration and setting up and initializing system parameters. The network management and system monitoring aspect of the SMU 165 supports the functions of real-time system monitoring of hardware and software, tracking of resource usage and monitoring traffic statistics and load. The SMU 165 also provides statistics and reporting through supporting standard built-in reports, custom reports and usage and loading reports. The SMU 165 provides fault management and alarms by supporting a centralized logging and reporting of faults, alarms in real time and discovery functions. Subscriber and mailbox administration is provided in the SMU 165 through supporting the ability to add, delete, modify, query and configure subscriber records, defining features on a subscriber basis and maintaining subscriber records and COS creation. The SMU 165 provides a computer interface for centralized provisioning including automated provisioning directly from external billing/provisioning systems via a flexible key-word interface.

The SMU 165 uses a dual processor computer and allows remote dial-in for access to the SMU 165 as well as all other servers in the system via Telnet. Backup of system configurations and other critical data is also accomplished via the SMU 165.

The next generation message store (NGMS) 160 operates to store voice messages, video messages and subscriber records, as well as manages specific functions including notification. Thus, in the illustrated embodiment, the NGMS 160 provides storage for both voice and video messages. The system can employ the use of multiple NGMS components to increase the memory size and the number of subscribers that can be supported.

The SGF 122 offers a consolidated SS7 interface creating a single virtual SS7 signaling point for the system. SS7 provides the extra horsepower networks need, whether large or small. Sigtran interface (IETF SS7 telephony signaling over IP) to the media servers as well as IP Proxy functions are supported via SGF. Consolidating SS7 provides the benefits of reduced point codes and easier maintenance.

The availability of point codes is typically limited. The consolidation of signaling links eases the pressure on these resources or eliminates the need for additional point codes altogether. In this way, the SGF 122 provides immediate network simplification and cost savings. The SGF 122 presents the appearance of a single identity to the SS7 network via the single “virtual” point code of the network and recognizes and processes messages in a transparent manner. The SGF 122 reduces the maximum number of point codes needed in some cases from 50 to only 4.

Various features, advantages and benefits of the SGF 122 include:

allowing multiple multi-function media servers to share signaling links and point codes (PC) providing significant cost savings;

providing concentrated SS7 signaling links;

providing one trunk group across multiple multi-function media servers; and

requiring less SS7 links resulting in reduced monthly connection fees

Thus, the present invention includes an integrated telecommunications platform that supports video mail, voicemail and optionally fax messages simultaneously with simplified access to each type of message. The NGMS 160 provides message storage and retrieval for video, voice and fax within a subscriber's mailbox. In one embodiment, the subscriber can access video mail, voicemail and fax messages separately, and in another embodiment, the subscriber can access all messages in an integrated manner.

A single user profile can be defined to support all of the available services. The SMU 165 provides the provisioning interface to access the subscriber records and to enable and disable services. Individual services such as video mail, voicemail and fax can be selected and configurable on a class of service and user profile basis.

The video deposit operation stores video message content in a different format from voice messages. Incoming video messages are recorded on the video media server 120. The recorded messages are saved as raw audio and video data—stored separately. The message durability techniques are then used to move these messages to the application server 150. Advantageously, storing the audio and video portions of the message separately decreases the complexity of the system. For instance, the data rates for audio and video are different, and the difference amount varies, making simple interleaving difficult. If the two data types were to be interleaved, an extended file format such as AVI or 3GP would have to be used. This would increase the processing load on the video media server 120. At playback time, the audio and video data must be fed separately to the video media server 120 software stack, at different and varying rates. If the streams are interleaved, additional processing and buffering are required on the video media server 120 to accommodate playback. In addition, there are circumstances when only a portion of a message (i.e., the audio portion or the video portion) needs to be retrieved. If the two data types were combined, the NGMS 160 would have to have knowledge of the internal structure of the data (e.g. AVI) to retrieve just the audio or video part. Storing the audio and video separately avoids this issue.

The NGMS 160 operates to manage both audio messages, as well as video messages with or without audio. An account and message database within the NGMS 160 keeps track of the video messages thereby allowing the current applications to work with video messages. Message waiting notification features available for voice messages are also applied for video messages. Thus, those skilled in the art will appreciated that the video, voice and fax messages are stored in the NGMS 160 and are accessible by the subscriber.

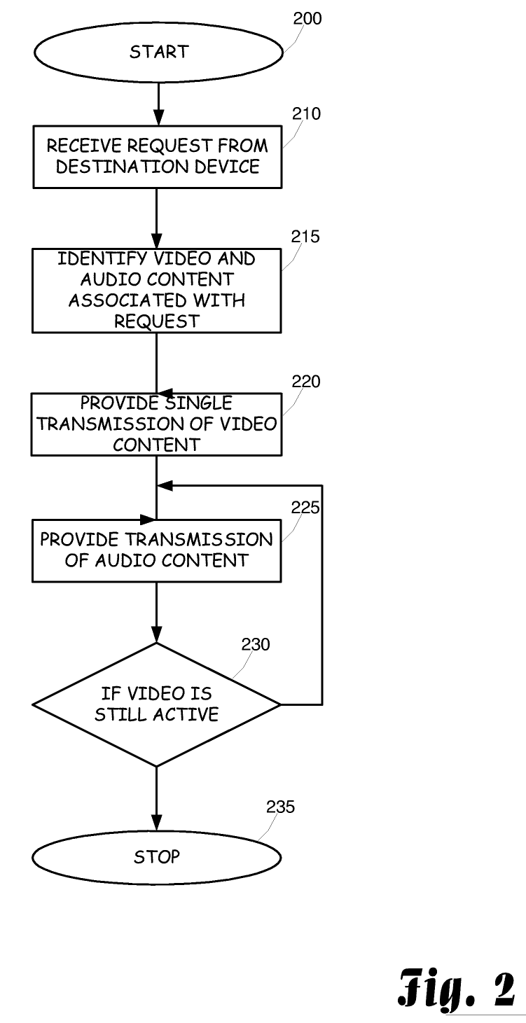

FIG. 2 is a flow diagram of an aspect of the present invention in providing bandwidth efficient delivery of still video content, such as menu screens. The process 200 is initiated and the first step in the process is the reception of a request from a destination device 210, such as a digital wireless handset equipped with the ability to render video content. The request could be any of a variety of request, including calling in to retrieve the subscriber's voice mail, calling a subscriber and receiving the voice mailbox of the subscriber, calling an information service or the like. The request is typically processed by the video media server (120 in FIG. 1) but the processing could be shared by other systems or performed by other devices depending on the particular embodiment of the invention. In any of the scenarios, the request is received by the telecommunications system. The request is then processed to identify the video and audio content, if any, that is associated with the request 215. This process may involve a query to a message storage device that searches based on the particular parameters of the request, the identity of the calling party, the identity of the called party, or other characteristics.

Once the video and audio content associated with the request is identified, the video content is transmitted to the destination device 220. The audio content is likewise transmitted to the destination device 225 either in parallel or in proximity to the transmission of the video content. In general, the video content is a static display, such as a menu screen or other information screen and the audio content is associated with the video content. As a non-limiting example, if the video content is a menu screen with various options, the audio content can be a recitation of the options available on the menu screen and/or instructions to the user regarding the options available. Upon completion of the playback of the audio content, if the video content is still active on the destination device 230 (i.e., the user has not selected a menu option causing a transition to a new screen or an application) then the audio content is retransmitted to the destination device 225. However, if the video content is no longer active, then processing stops 235. Thus, it will be appreciated that this aspect of the present invention provides a continuous loop of the video and audio content until a user takes an action that invokes a status change, such as a request for additional content, cancellation of the playback, invoking an action, etc. Advantageously, because the present invention operates to store the audio and video content separately, the audio content can be transmitted multiple times while the video content is only transmitted once. This aspect of the invention reduces the bandwidth requirements in providing such audio and video content to a destination device.

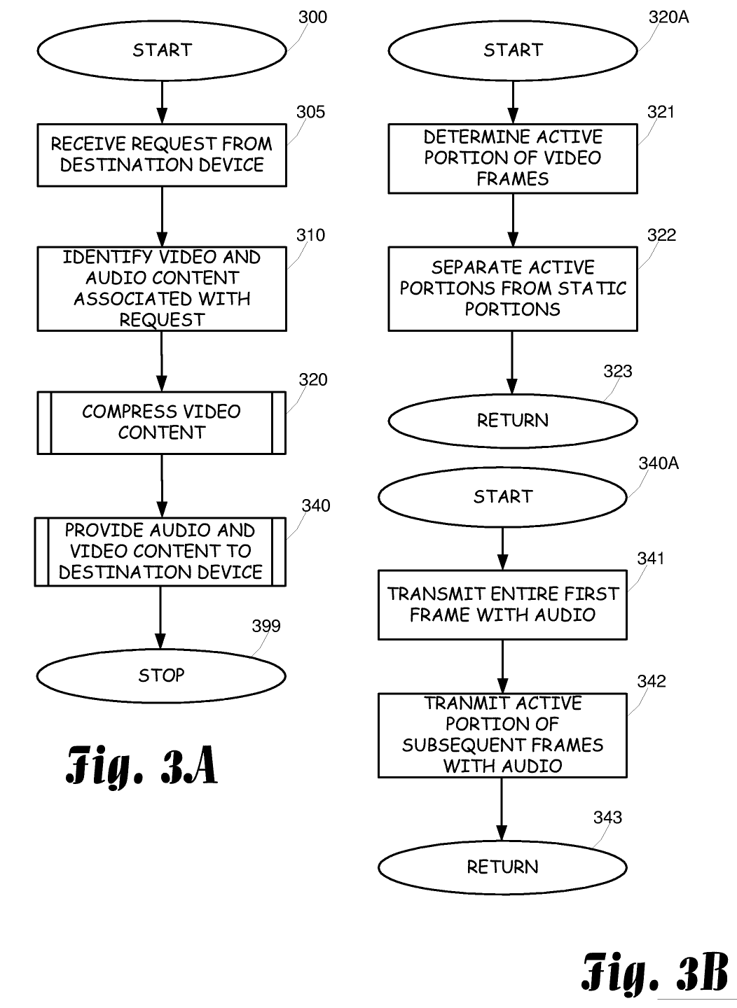

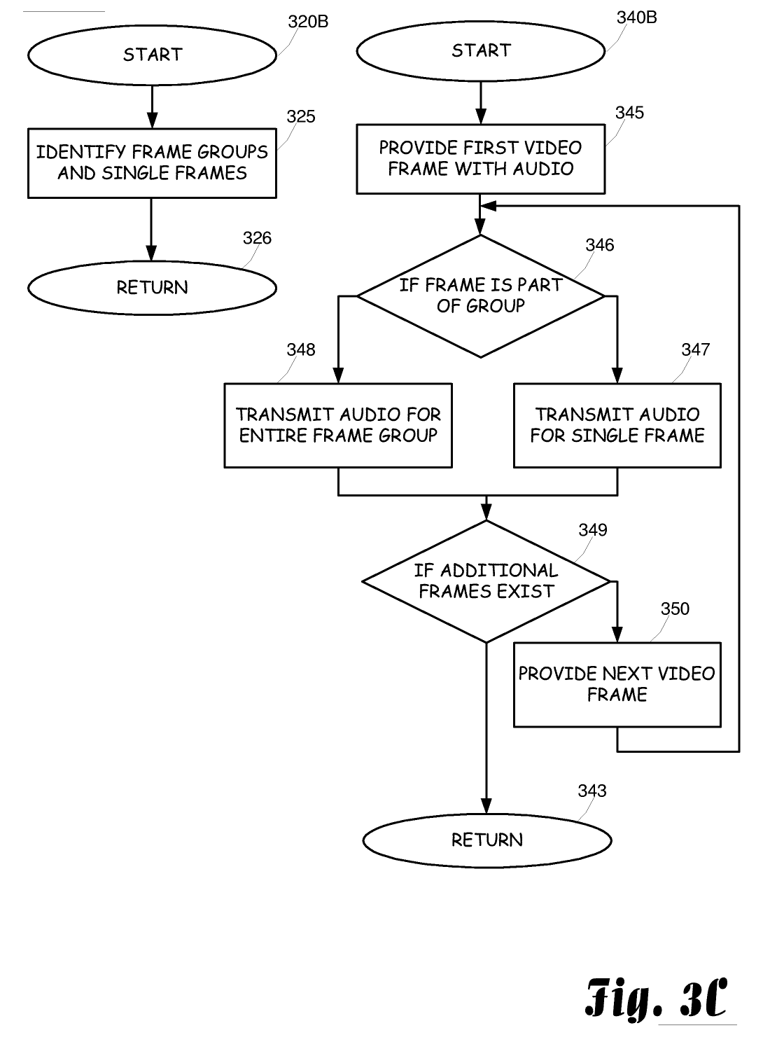

FIGS. 3A and 3B are flow diagrams embodiments of the present invention operating to provide bandwidth efficient delivery of active video content. More specifically, FIG. 3A is the high-level flow chart for an embodiment of the present invention enabling the bandwidth efficient delivery of active video content. FIG. 3B is a flow diagram illustrating an embodiment of the invention in which compression of the video content is performed on a content level. FIG. 3C is a flow diagram illustrating an embodiment of the invention in which compress is performed on a frame-by-frame basis.

In FIG. 3A, the process 300 commences upon the reception of a request from a destination device 305. The destination device in this embodiment, as well as other embodiments described herein, can be any of a variety of devices, including digital wireless telephones, 3G enabled devices, computers, laptops, personal data assistance, pocket personal computers, or the like. Although the present invention is particular focused on the provision of bandwidth efficient video content to digital wireless devices, the various aspects and features of the present invention can be equally applied to the delivery of any video content.

The request from the destination device can take on a variety of forms. For instance, the request may simply comprise a destination device making a call to a number that is controlled or supported by a video mail system. Likewise, the request could be an action taken by a destination device during a telephonic connection to a video mail system or telecommunications system supporting video content. As non-limiting examples, the request could be invoked by a subscriber calling into his or her voice mail box, receiving a call from a subscriber, requesting a playback of video mail, traversing menu structures of a video mail system, a calling party rolling over to video mail to receive a subscriber's personal video message, or the like. In these examples, as well as other examples that will be readily apparent to the reader, the system operates to identify the video and/or audio content associated with the request 310.

Upon identifying the video and/or audio content, the video content is subjected to a compression process 320. The compressed video and any associated audio is then provided to the appropriate destination device 340. Processing then ends at 399 until the reception of another request or event that would invoke the delivery of additional content.

FIG. 3B is a flow diagram illustrating an embodiment of the invention in which compression of the video content is performed on a content level. In this embodiment 320A, the video content is analyzed. The analysis can be conducted in a variety of manners, including but not limited to, (a) serially analyzing the video content as it is being transmitted, (b) analyzing the video content in buffered blocks or (c) analyzing the entire video content prior to transmission. Regardless of the technique employed, the active portions of the video content and the static portions of the video content are identified. For instance, in a series of menu screens to be delivered, the static content could be the background of the menu screen and the options or selections that do not change from screen to screen. The active content could be the menu items or, if options are high-lighted in synchronization with the audio, the active portions may include the bolding or high-lighting of the particular menu items. In a moving video picture image, the static content could be the background and other elements that are not moving, while the active content may include the moving objects. For instance, if the video picture image is a subscriber reciting a message, the background and portions of the subscriber that are not moving or are substantially still may be considered static, while the subscriber's mouth, eyes and other moving elements may be considered active content. Regardless of the particular technique employed, the active portions of the video are separated or distinguished from the static portions of the video 322. Processing then returns to step 340 in FIG. 3A.

Once the active and video content are identified and separated, the video content is delivered to the destination device 340A. In this embodiment, the entire first frame of the video content is transmitted to the destination device along with the synchronized audio 341. The entire first frame is transmitted because, in essence, the entire first frame would be considered active content. For the next and subsequent frames of the video content, only the active portions are transmitted along with the synchronized audio associated with that frame 342. Processing then returns to step 399 in FIG. 3A.

It will be appreciated that this embodiment of the present invention can deliver the video and audio content in a manner that reduces the bandwidth requirements. Because only the active portions of a video image are transmitted, the bandwidth requirements are reduced.

FIG. 3C is a flow diagram illustrating an embodiment of the invention in which compress is performed on a frame-by-frame basis. In this embodiment 320B, the video content is analyzed. The analysis can be conducted in a variety of manners, including but not limited to, (a) serially analyzing the video content as it is being transmitted, (b) analyzing the video content in buffered blocks or (c) analyzing the entire video content prior to transmission. Regardless of the technique employed, video content is grouped into similar of substantially similar frames and independent frames. The grouping is based on the comparison of content from one frame to the next. For instance, if several frames of a video stream are substantially similar or identical, these frames are considered to be in a group of frames. A grouping of frames can be caused by many factors, such as but not limited to, the subject of the video maintaining a constant position, the video being directed towards a static image such as a chalk board, a prototype or other static images, etc. In other circumstances, the content in the video stream may be rapidly changing and thus, independent frames, or frames that cannot be grouped together may exist. Once the frames or a portion of the frames have been analyzed, processing returns to step 340 in FIG. 3A.

The video content, once analyzed is then provided to the destination device 340B. The first video frame, which may represent a frame group or a single independent frame is transmitted to the destination device along with the associated and synchronized audio content 345. At step 346, if the first frame is an independent single frame, only the audio associated with that frame is transmitted 347. Alternatively, if the frame is associated with a frame group, the audio associated with each frame in that frame group is transmitted 348.

If additional frames need to be transmitted 349, the next video frame is obtained 350 and processing returns to step 346. Otherwise, processing returns to step 399 of FIG. 3A to await the next request for video content.

Thus, it has been shown that the present invention provides a system and a technique for providing video content in a bandwidth efficient manner. Although the primary application for the invention has been described as providing video content over a digital cellular wireless network, those skilled in the art will appreciate that the various aspects and features of the present invention can be equally applied in the delivery of video content over any transmission medium. Thus, the present invention has been described using detailed descriptions of embodiments thereof that are provided by way of example and are not intended to limit the scope of the invention. The described embodiments comprise different aspects and features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

What is claimed is:

1. A method for providing bandwidth efficient delivery of video content over a digital wireless telecommunications network, the method comprising the steps of:
receiving a request at a communications platform, the request being associated with a destination device and associated with the provision of video and audio content to the destination device;
retrieving the video and audio content associated with the request;
processing the video content through a compression technique;
providing the processed video content to the destination device; and
providing the audio content to the destination device.

2. The method of claim 1, wherein the step of processing the video content through a compression technique further comprises:
determining that the video content is a still image and
the step of providing the processed video content further comprises providing the still image to the destination device a single time, independent of the manner for providing the audio content to the destination device.

3. The method of claim 2, wherein the video content is a menu screen and the audio content is associated with the content of the menu screen, and the step of providing the audio content to the destination device further comprises providing the audio content in a continuous loop.

4. The method of claim 1, wherein the video content comprises a plurality of video frames and the step of processing the video content through a compression technique further comprises:
determining that the video content of the plurality of video frames includes some active video portions;
separating the active video portions from static video portions; and
the step of providing the processed video content to the destination further comprises:
initially providing and entire first frame that includes the active and static video portions; and
providing only the active portions of subsequent video frames.

5. The method of claim 4, wherein the video content is a series of menu screens with menu items, the active portions of the video frames includes serially augmenting each menu item in the menu screen, and the audio content is associated with the menu items of the series of menu screens, and the steps of providing the audio content to the destination device further comprises:
synchronizing the provision of the audio content with the video content such that as each menu item in the menu screen is augmented, the audio content associated with the augmented menu item is provided.

6. The method of claim 1, wherein the video content comprises a plurality of video frames and the step of processing the video content through a compression technique further comprises:
identifying a first frame group of contiguous frames of the plurality of video frames in which the video content is substantially static; and
the step of providing the processed video content to the destination further comprises providing only a single frame of the first frame group.

7. The method of claim 6, further comprising the steps of:
identifying a second frame group of contiguous frames of the plurality of video frames in which the video content is substantially static; and
the step of providing the processed video content to the destination further comprises providing only a single frame of the second frame group.

8. The method of claim 7, wherein the next frame provided after the single frame of the first frame group may be a single frame of a second frame group or a single independent frame.

9. The method of claim 8, wherein the audio content is synchronized with the plurality of video frames, and the step of providing the audio content further comprises maintaining synchronization of the audio content such that as the single frame of the first frame group is displayed, the audio content associated with the entire frame group is provided to the destination device and, when the next frame is provided to the destination group, the audio content associated with that next frame is provided.

10. A telecommunications system that provides bandwidth efficient delivery of video content to a destination device on a digital wireless network, the telecommunications system comprising:
a transcoding gateway interfacing to the digital wireless network for receiving control, video and audio content and for providing response, video and audio content to the destination devices on the digital wireless network;
a message store for storing video and audio content;
a video media server interfacing to the transcoding gateway and the message store, and in response to receiving control content requesting the provision of video and audio content, being operable to:
retrieve the video and audio content associated with the control content request from the message store
process the video content through a compression technique;
provide the processed video content and audio content to the destination device in a synchronized manner.

11. The telecommunications system of claim 10, wherein the video media server is operable to:
process the video content through a compression technique by determining that the video content is a still image; and
provide the processed video and audio content to the destination device in a synchronized manner by providing the still image to the destination device a single time, independent of the manner for providing the audio content, and providing the audio content in a loop while the still image is being displayed on the destination device.

12. The telecommunications system of claim 10, wherein the video content comprises a plurality of video frames and the video media server is operable to provide the video content through a compression technique by:
determining that the video content of the plurality of video frames includes some active video portions;
separating the active video portions from static video portions; and
the video media server is operable to provide processed video and audio content to the destination device by:
initially providing and entire first frame that includes the active and static video portions; and
providing only the active portions of subsequent video frames.

13. The telecommunications system of claim 12, wherein the video content is a series of menu screens with menu items, the active portions of the video frames includes serially augmenting each menu item in the menu screen, and the audio content is associated with the menu items of the series of menu screens, and the video media server is operable to provide the audio content to the destination device by:
synchronizing the provision of the audio content with the video content such that as each menu item in the menu screen is augmented, the audio content associated with the augmented menu item is provided.

14. The telecommunications system of claim 10, wherein the video content comprises a plurality of video frames and the video media server is operable to process the video content through a compression technique by identifying a first frame group of contiguous frames of the plurality of video frames in which the video content is substantially static; and
the video media server is operable to provide the processed video and audio content to the destination device by providing only a single frame of the first frame group.

15. The method of claim 14, wherein the video media server is further operable to:
identify a second frame group of contiguous frames of the plurality of video frames in which the video content is substantially static; and
provide the processed video content to the destination by providing only a single frame of the second frame group.

16. The telecommunications system of claim 15, wherein the video media server provides a next frame to the destination device after the single frame of the first frame group and the next frame may be a single frame of the second frame group or a single independent frame.

17. The telecommunications system of claim 16, wherein the audio content is synchronized with the plurality of video frames, and the video media server provides the processed video and audio in a synchronized manner such that as the single frame of the first frame group is displayed, the audio content associated with the entire frame group is provided to the destination device and, when the next frame is provided to the destination group, the audio content associated with that next frame is provided.

18. The telecommunications system of claim 1, wherein the transcoding gateway receives audio and processed video content from the video media server and converts it into a format suitable for the destination device.

19. A method for providing bandwidth efficient delivery of video content over a digital wireless telecommunications network, the method comprising the steps of:
receiving a request at a communications platform, the request being associated with a destination device and the request being associated with the provision of video and audio content to the destination device;
retrieving the video and audio content associated with the request;
processing the video content by:
upon determining that the video content is a still image, providing the processed video content by providing the still image to the destination device a single time, independent of the manner for providing the audio content to the destination device; and
upon determining that the video content comprises a plurality of video frames and that the video content of the plurality of video frames includes some active video portions:
separating the active video portions from static video portions; and
providing the processed video content to the destination by initially providing and entire first frame that includes the active and static video portions and providing only the active portions of subsequent video frames.

20. The method of claim 19, the active video portions and the static video portions are determined on a frame by frame basis, and the step of providing the processed video content to the destination further comprises providing a first frame, and then providing a next frame when the content of the next frame is substantially different from the first frame.
